(19) United States
(12) Patent Application Publication
(10) Pub. No.: US 2016/0334138 A1
(43) Pub. Date: Nov. 17, 2016

(54) CONTROLLABLE HEATED FLUID AND/OR VAPOR VESSEL SYSTEM AND METHOD FOR CONTROLLABLY HEATING A FLUID AND/OR VAPOR VESSEL

(71) Applicant: ENGENITY, LLC, Minneapolis, MN (US)

(72) Inventor: Richard S. GARBER, St. Paul, MN (US)

(21) Appl. No.: 14/713,707

(22) Filed: May 15, 2015

(51) Int. Cl. F24H 9/20; H05B 3/00; F24H 1/00

(52) U.S. Cl. CPC F24H 9/2014; F24H 1/0018; H05B 3/0014

(57) ABSTRACT

A heated vessel system includes a vessel for containing a fluid, a heating element in contact with the vessel and configured to heat the vessel, a first temperature sensor configured to sense a temperature of the vessel or the fluid in the vessel, and a second temperature sensor connected to the heating element so as to sense a temperature of the heating element. A controller selectively operates the heating element to control the temperature of the vessel or the fluid in the vessel. The controller is configured to energize the heating element when (1) the temperature of the heating element is less than a selected high limit temperature of the heating element and (2) the temperature of the vessel or the fluid in the vessel is less than or equal to a selected upper limit temperature.

### FIELD OF THE INVENTION

This invention pertains to insulated and electrically heated fluid and vapor vessels, including insulated and electrically heated fluid and vapor conduits and containers. More particularly, this invention pertains to the systems and methods that control the heating elements of such insulated and electrically heated fluid and vapor vessels.

### BACKGROUND

Insulated and electrically heated conduits, such as pipes, hoses, fittings, etc., are used to convey fluids and vapors for a wide variety of purposes in a wide variety of applications. Similarly, there are insulated and electrically heated fluid and vapor containers for a wide variety of purposes in a wide variety of applications.

Most insulated and electrically heated fluid and vapor conduits and containers require that (1) the conduit's or container's temperature be raised from some minimum to some operating value greater than the minimum within a specified period of time and/or (2) heat be applied to the conduit or container to compensate for its natural heat loss. Regardless of why a particular fluid or vapor conduit or container is being heated and how that particular conduit or container is being heated, it is important that the power to the heater be distributed over the heater area and over time in such a manner that the conduit or container being heated can absorb the heat. Otherwise, too much heat remains in the heater, and the heater's lifespan is shortened or, in a worst case, the heater is damaged or destroyed. In that regard, many of the insulated and electrically heated fluid and vapor conduits and containers are made of rubber or polymer compounds that have poor thermal conductivity. Heat is not instantly or even quickly transferred from the heaters to those conduits and containers, or, by extension, to the fluid or vapor in those conduits and containers. For example, for the electric heaters that are often used for heating insulated and electrically heated hoses in diesel engines, it is generally accepted that power density be limited to 2.5 W/sq.in., in part, due to the low thermal conductivity and diffusivity of the polymers and rubbers that are typically used to make those hoses.

Accordingly, the heat generated by the heater of insulated and electrically heated fluid and vapor conduits and containers must be applied to the conduit or container over an interface area and a time span that does not damage the heater, the conduit or the container.

In conflict with that precaution, it is generally desirable to heat a conduit or container of an insulated and electrically heated fluid or vapor conduit or container as quickly as possible in order to minimize the time required to achieve the desired setpoint temperature of the system, TSET.

That dilemma is illustrated in FIG. 7. As illustrated in FIG. 7, when starting at a temperature that is much less than TSET, the temperature “paths” of conventional insulated and electrically heated conduits and containers may vary greatly based on whether the heater is “underpowered” to reduce the risk of damage due to overheating or “overpowered” to reach TSET as quickly as possible. As FIG. 7 implies, an uncontrolled heater that is designed to achieve TSET very quickly for some given ambient temperature could self-destruct when an ambient temperature is greater than the given ambient temperature. In contrast, in a situation in which the heater is underpowered, the time required to achieve TSET is much longer, if the system even achieves TSET at all.

The heating of many of the conventional insulated and electrically heated fluid and vapor conduits and containers is not “controlled,” i.e., the activation of the heating element is not dependent on the temperature of the heating element. Specifically, in those conventional insulated and electrically heated fluid and vapor conduits and containers, the conduits and containers are heated by either: (a) an electric heater of any of numerous styles of construction and having fixed resistance, and not connected to any means of (i) sensing its temperature, (ii) sensing the temperature of the conduit or container, or (iii) modulating the power delivered to it; or (b) an electric heater of the variable resistance type, commonly known as a positive temperature coefficient (PTC) heater, in which the resistance of the heating element varies in direct proportion to its ambient temperature, and as a result of which, the power dissipated by the heater varies in a correspondingly indirect manner. The shortcomings of those conventional insulated and electrically heated conduits and containers are many.

For example, with regard to heating a fluid or vapor conduit or container with an uncontrolled, fixed resistance heater, there are risks that, if the uncontrolled, fixed-resistance heater heats up to too high a temperature for the conduit or container being heated to convey the heat away from the heater as discussed above, the heater and/or the conduit or container being heated may be damaged.

With regard to heating a fluid or vapor conduit or container with a PTC heater, the current required to maintain the heater at the minimum turn-off temperature when the ambient temperature is relatively high in comparison to that minimum turn-off temperature may cause a very high inrush current at low ambient temperatures due to the heater's very low resistance at very low temperatures. If not sufficiently planned for, the very high inrush current may damage or degrade the electrical system to which the heated conduit or container is connected. Further, a common shortcoming of PTC heaters, especially in certain applications such as engine compartment applications, is that their performance is typically degraded by exposure to long-periods of high ambient temperature even when de-energized.

Some conventional insulated and electrically heated fluid and vapor conduits and containers measure the temperature of the conduit or container and turn off/on the heater based on that temperature. However, that control operation does not prevent the operational risks and inefficiencies discussed above. In addition, such conventional insulated and electrically heated fluid and vapor conduits and containers are unsuited to certain applications, such as conduits/containers containing diesel fuel, for other reasons: (1) they are too physically unwieldy for use in constrained spaces; (2) the thermostats have very constrained life cycles (typically 2500 switching cycles or fewer) when used in direct current powered applications; and (3) the thermostats have very wide tolerances of setpoint temperatures and operation with setpoints below certain temperatures is generally not guaranteed.

Accordingly, it is desirable to provide an insulated and electrically heated fluid and/or vapor conduit or container having a control system for the heater that achieves quick and efficient heating of the fluid in the conduit or container while minimizing the risk of damage to the heater, conduit or container.

### SUMMARY

According to various aspects of the disclosure, a heated vessel system includes a vessel for containing a fluid, a heating element in contact with the vessel and configured to heat the vessel, a first temperature sensor configured to sense a temperature of the vessel or the fluid in the vessel, and a second temperature sensor connected to the heating element so as to sense a temperature of the heating element. A controller selectively operates the heating element to control the temperature of the vessel or the fluid in the vessel. The controller is configured to (1) interrupt energizing of the heating element when the temperature of the heating element reaches a selected high limit temperature of the heating element and (2) interrupt energizing of the heating element when the temperature of the vessel or the fluid in the vessel exceeds a selected upper limit temperature.

In accordance with various aspects of the disclosure, a method of controllably operating a heated vessel system having a vessel and a heating element to heat the vessel includes sensing a temperature of the heating element, sensing a temperature of the vessel or the fluid in the vessel, and selectively operating the heating element to heat the vessel. The step of selectively operating includes (1) interrupting energizing of the heating element when the temperature of the heating element reaches a selected high limit temperature of the heating element and (2) interrupting energizing of the heating element when the temperature of the vessel or the fluid in the vessel exceeds a selected upper limit temperature.

In some aspects of the disclosure, a heated vessel system includes a vessel for containing a fluid, a heating element in contact with the vessel and configured to heat the vessel, a first temperature sensor configured to sense a temperature of the vessel or the fluid in the vessel, and a second temperature sensor connected to the heating element so as to sense a temperature of the heating element. A controller selectively operates the heating element to control the temperature of the vessel or the fluid in the vessel. The controller is configured to energize the heating element when (1) the temperature of the heating element is less than a selected high limit temperature of the heating element and (2) the temperature of the vessel or the fluid in the vessel is less than or equal to a selected upper limit temperature.

### BRIEF DESCRIPTION OF THE DRAWINGS

FIG. 1 is a perspective view of an exemplary controllable heated vessel according to various aspects of the disclosure,

FIG. 2 is a cross-sectional view of the exemplary controllable heated vessel of FIG. 1 taken along line II-II,

FIG. 3 is a schematic diagram of an exemplary control circuit of a controller in accordance with various aspects of the disclosure,

FIG. 4 is a graph illustrating an exemplary operation of the control circuit in accordance with various aspects of the disclosure.

FIG. 5 is a flow chart illustrating an exemplary operation in accordance with various aspects of the disclosure.

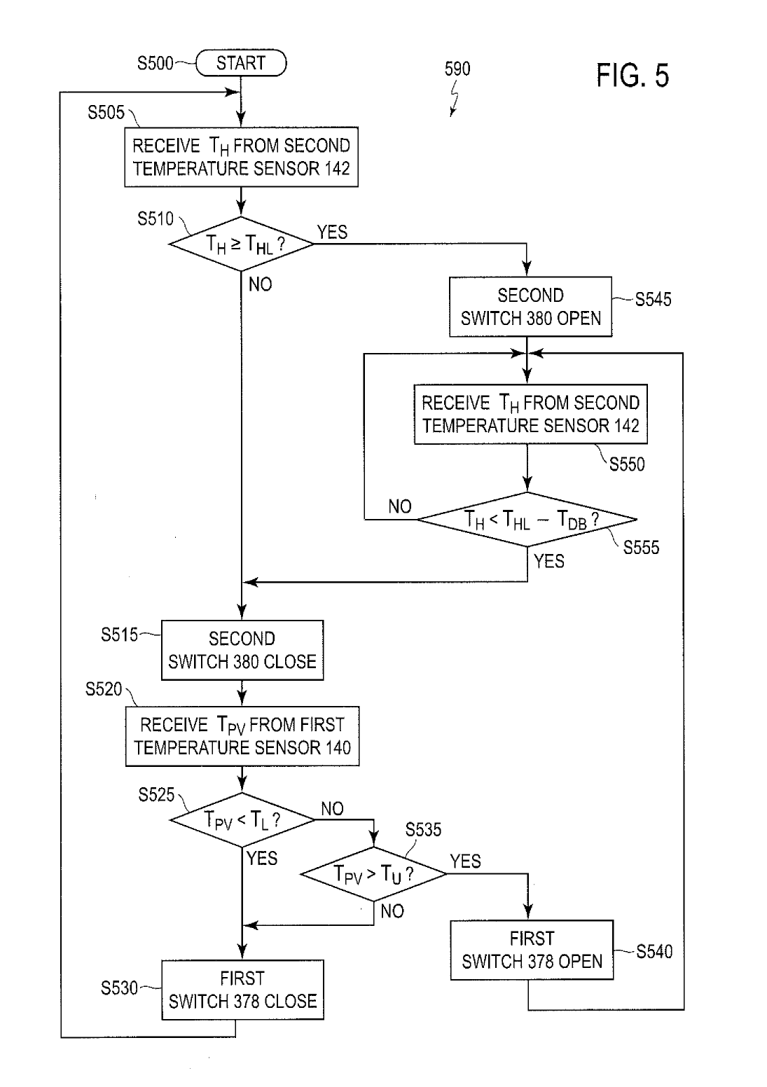

FIG. 6 is a diagrammatic view of an exemplary controllable heated vessel according to various aspects of the disclosure.

FIG. 7 is a graph illustrating an example of operation of a conventional uncontrolled vessel heating system.

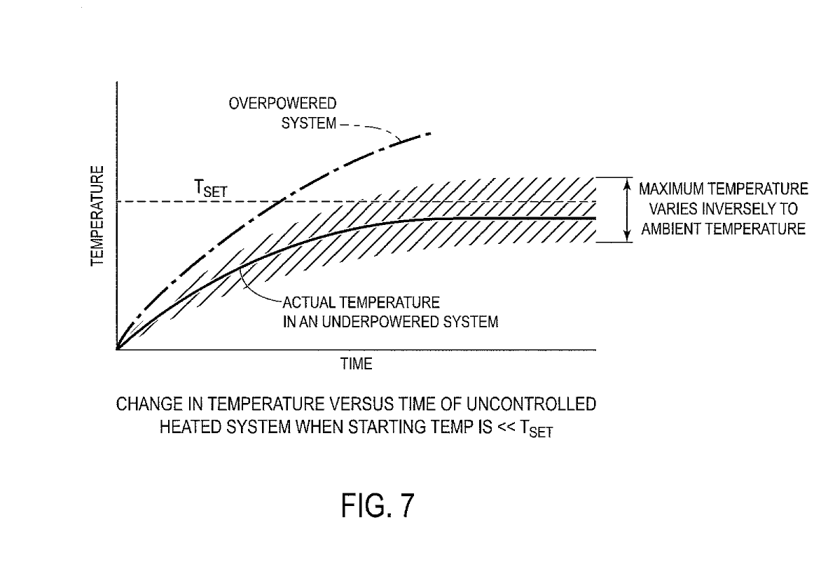

FIG. 8 is a flow chart illustrating an exemplary operation in accordance with various aspects of the disclosure.

FIG. 9 is a flow chart illustrating an exemplary operation of the regulation of the process-value temperature, T_{PV}, within the system in accordance with various aspects of the disclosure.

### DETAILED DESCRIPTION OF THE EMBODIMENTS

This detailed description refers to the accompanying figures. The same reference numbers in different figures may identify the same or similar elements. Also, this detailed description does not limit the invention.

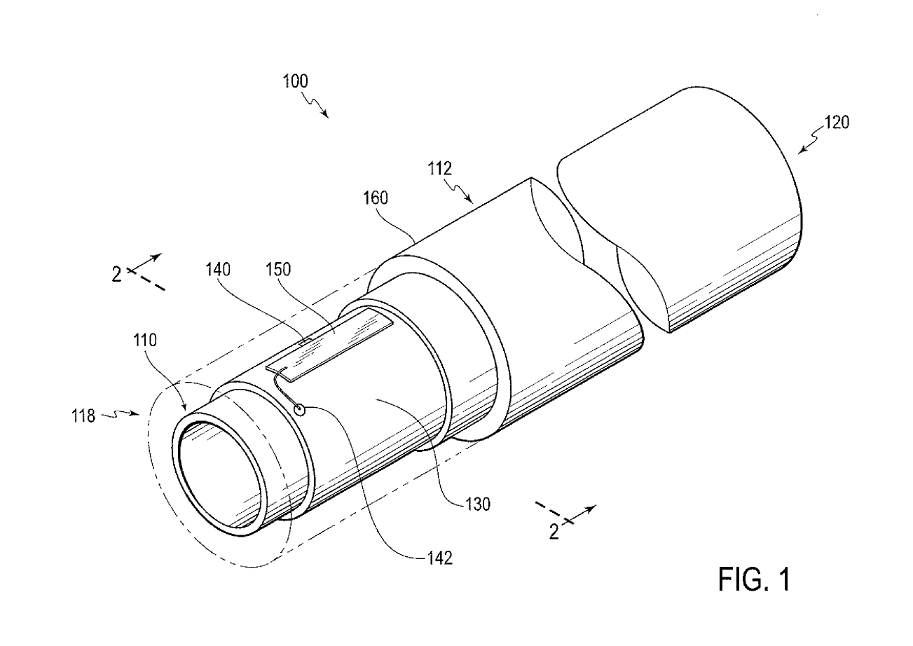

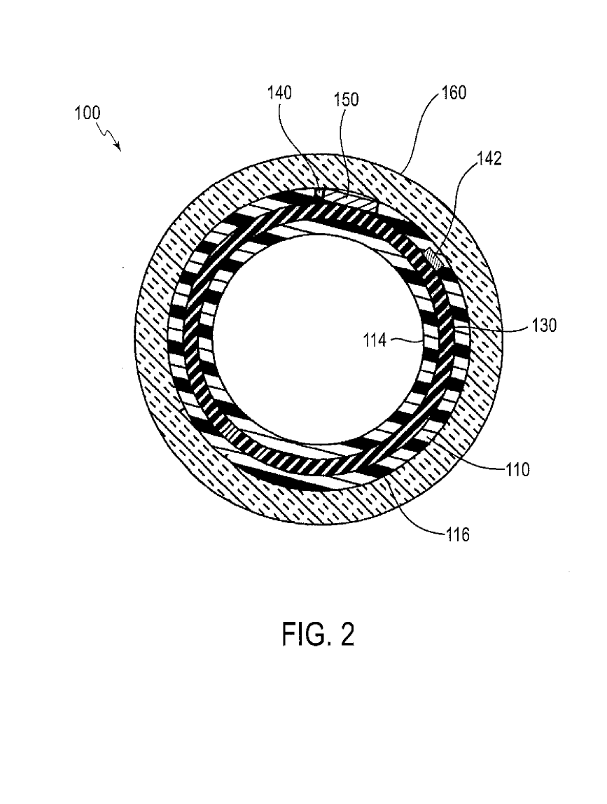

As illustrated in FIGS. 1 and 2, an exemplary controllable heated vessel system 100 of this invention may include a vessel 110 for containing a fluid and/or a vapor, a heating element 130 associated with the vessel 110, a temperature controller 150 configured to control operation of the heating element 130 to maintain a desired temperature of fluid in the vessel 110, and an outer layer 160 covering the temperature controller 150, the heating element 130, and the vessel 110.

In various embodiments of the invention, the vessel 110 may be a conduit or a container. In the embodiment of FIGS. 1 and 2, the vessel 110 is a conduit. A conduit of this invention may include, but is not limited to being, a hose, a pipe, a fitting, or any other fluid conveyor.

Specifically, referring to FIGS. 1 and 2, the vessel 110 is an elongated hose 112 having an inner wall 114 and an outer wall 116. The vessel 110 includes a first end 118 and a second end 120. The inner wall 114 contains the fluid flowing through the elongated hose 112 from the first end 118 to the second end 120 or vice versa. The first and second ends 118, 120 may each include a coupling member (not shown) for coupling to a fluid supply and a destination for the fluid. In some embodiments of this invention, the vessel 110 may be flexible, in other embodiments, the vessel 110 may be rigid, and in yet other embodiments, the vessel 110 may include flexible and rigid portions.

The heating element 130 may be, for example, a resistance heater. Specifically, the heating element 130 may be an electric heater having a fixed resistance or a variable resistance heater such as, for example, a positive temperature coefficient (PTC) heater, The heating element 130 is heated, for example, by the passage of electricity therethrough. The heat from the heating element 130 heats the vessel 110, which, in turn, heats the fluid in the vessel 110.

In addition, while in FIGS. 1 and 2, the heating element 130 is illustrated as extending the length of the vessel 110 and the entire circumference of the vessel 110, in other embodiments, the heating element may extend along a portion or all of the length of the vessel 110 and about a portion of or the entire circumference of the vessel 110. In other embodiments, the heating element 130 may be partially or fully embedded in the vessel 110 between the inner wall 114 and the outer wall 116, as shown in FIG. 2. In yet other embodiments, the heating element 130 may be on the vessel 110, for example, on the outer wall 116 of the vessel 110. The heating element 130 may be flexible, rigid, or partially flexible and partially rigid. Further, the heating element 130 may be of many forms, including a sheet, a spiral wire, a cable, or the like.

Thermally, it is preferable to have the heating element 130 extend along substantially the entire length of the vessel 110 and to have the heating element 130 envelop the vessel 110 being heated as much as possible. However, in many applications and environments, constraints may preclude that design.

For example, when the vessel 110 is a flexible hose, it is likely that in use the hose could flex at multiple points along any number of vectors in three dimensions. However, heating elements built on polymer or rubber substrates are, for practical purposes, only capable of flexing around one axis at a time. Thus, when utilizing the heating element 130 in a flexible hose, it may be desirable to minimize a single dimension (for example, “width” in the case of the illustration) so as to ensure that the heating element will maintain as much surface contact with the object being heated as possible, regardless of how it is bent or twisted.

As another example, when a hose will be secured in a relatively fixed position with multiple sharp bends and with the center line of the hose residing on multiple planes over its length, multiple heating elements of different lengths may be used in the sections that are generally straight. In that situation, the conduction of heat through the hose can be relied upon to heat the “bend” regions, i.e., heat will conduct from adjacent straight sections to the “bend” regions, and the element that senses the system temperature, T_{SET}, is preferably positioned at the center of a “bend” region.

Further, in the specific case of a heated hose, the heating element(s) may not extend into the end sections of the hose if clamping mechanisms will be used to attach the hose ends to other components.

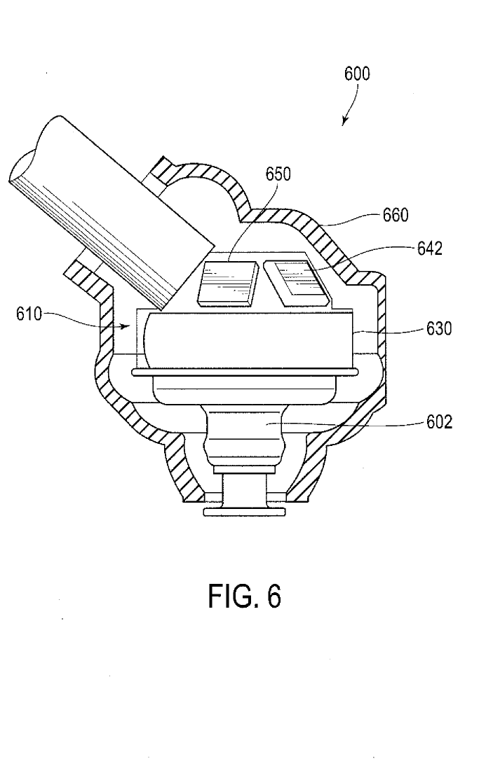

Referring to FIG. 6, showing the heating of an oil filter assembly (discussed in more detail below), the optimal and most practicable heating is achieved by having the heating element in the largest planar surface area when the heated object (in this case, oil filter housing) is “unrolled” or flattened, such that the heating element will only be required to flex about one axis during installation. Further, in such instances, the sensor that senses the system temperature is optimally located at the top of the assembly because heat rises, albeit the heat will conduct quickly to the sensor if the filter assembly's housing is metallic regardless of the location of the sensor,

Referring again to FIG. 2, in the event that the temperature controller 150 includes a built-in sensor for sensing the average system temperature, there should be a separation in the heating element 130, so that the temperature controller 150 is in contact with the vessel wall.

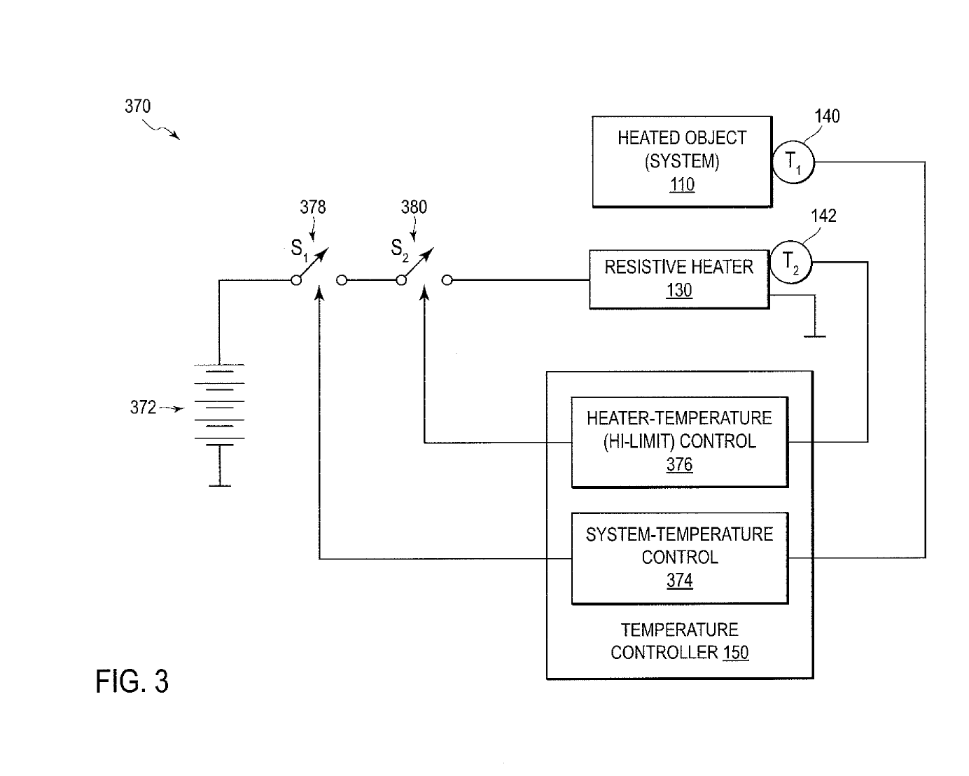

The heating element 130 is electrically coupled to a source of electricity 372, as shown in FIG. 3. The selection of an electrical connector and connector methodology is application and customer specific. For example, the electrical connector may be an off-the-shelf connector, such as those manufactured by Deutsch, Amphenol, Tyco, and others.

The outer layer 160 of the system may comprise an insulating material positioned over the vessel 110, as shown in FIG. 2, for containing the heat produced by the heating element 130 within the vessel 110 and the fluid in the vessel 110. The insulating material can be determined based on the particular application of the vessel 110.

For example, the insulating material can be a variety of closed-cell polymer foams. If desired and/or if needed, a flexible covering material can be used to protect the outside of the foam.

As a more specific example, a heating jacket that is intended for field installation on a rigid vessel may be constructed of nylon foam, such as, for example, Zotek N B50. Zotek N B50 has the advantages of chemical resilience, wide range of allowable operating temperatures, and mechanical rigidity. In those instances, the foam can act as a carrier for the heating element(s) and the controller.

In the case of a heated hose, the insulating material may be, for example, ArmaFlex® brand insulation manufactured by ArmaCell, which can be slipped over the hose/heater/temperature controller assembly. That insulation could be the outer material of the installation, or a braided flexible protective outer layer can be added to provide additional mechanical and chemical protection. One exemplary outer layer material is Gorilla Sleeve manufactured by Techflex.

The system 100 includes a first temperature sensor 140 and a second temperature sensor 142.

The first temperature sensor 140 is coupled to the vessel 110 in such a manner as to sense the temperature TPV of the vessel 110. The first temperature sensor 140 may be integrated into the temperature controller 150 or separate from the temperature controller 150. Alternatively, the first temperature sensor 140 can be located such that it measures the temperature of fluid in the vessel.

The second temperature sensor 142 is in direct or indirect contact with the heating element 130 so as to measure a temperature of the heating element, such as the surface temperature TH of the heating element 130. The second temperature sensor 142 may be, for example, a thermocouple, resistive temperature detector, or thermistor,

In other embodiments, multiple sensors can be utilized to determine the temperature TPV of the vessel 110 and/or the surface temperature TH of the heating element 130.

The temperature controller 150 controls the flow of electrical power to the heating element 130 from the source of electricity in order to control the degree of heating of the heating element 130 and the resulting heating of the fluid in the vessel 110, as described below. The temperature controller 150 may be integrally formed with the vessel 110.

The temperature controller 150 may be, for example, a microcontroller including a processor and a computer-readable memory to store instructions which, when executed by the processor, cause the processor to perform operations, a method or other specific actions. The temperature controller 150 may also include a communications interface configured to communicate with an input device and/or an output device via a wired or wireless connection

The temperature controller 150 may be similar to the controller described in U.S. Pat. No. 8,500,034, the subject matter of which is incorporated herein by reference. In some embodiments, the temperature controller 150 utilizes more than two inputs and is capable of controlling more than two heating elements. Communications between the heated vessel and the host system, or between controller components of a multi-vessel system will utilize standardized communication devices and protocols such as CANBus, Bluetooth, and the like.

The temperature controller 150 may include a system temperature control module 374 and a heating element current switching module 376.

Referring to FIG. 3, the temperature controller 150 is associated with a thermostat control circuit 370 which is the path for the electricity from the source of electricity 372 to the heating element 130. The circuit 370 includes a first switch 378 operated by the system temperature control module 374 and a second switch 380 operated by the heating element temperature control module 376. The order of the switches—i.e., current passing through switch 378 then through switch 380, or vice versa—is not important. In fact, in some implementations a MOSFET is used as the actual current interrupter. The MOSFET is a single functional device, and the switches 378 and 380 exist in the microcontroller,

The system temperature control module 374 can be programmed with an upper limit temperature TU and a lower limit temperature TL, When the temperature TPV sensed by the first temperature sensor 140 is greater than the upper limit temperature TU, the system temperature control module 374 interrupts the flow of electricity to the heating element 130 via the first switch 378, and that power remains interrupted until the temperature sensed by the first temperature sensor 140 is less than the lower limit temperature TL.

The heating element current switching module 376 can be programmed with high limit temperature THL. When the surface temperature TH of the heating element 130 sensed by the second temperature sensor 142 is greater than or equal to the high limit temperature THL, the heating element current switching module 376 interrupts the flow of electricity to the heating element 130 via the second switch 380,

The heating element current switching module 376 can also be programmed with a dead-band temperature span TDB, which is a temperature range immediately below the high limit temperature THL. When the surface temperature TH of the heating element 130 is at temperature THL−TDB after the surface temperature TH reaches the high limit temperature THL, the second switch 380 will be closed to enable the flow of electricity to the heating element 130, again until the surface temperature TH reaches the high limit temperature THL.

The deadband span is selected empirically on a case-by-case basis and is based on the particular application requirements. One consideration that determines the deadband span is the system's tolerance to on/off switching of the current. For example, if it is desirable to minimize the on/off switching of the current, in order to prevent undesired radio frequency emissions, the deadband span may be relatively large. Another consideration is the system's tolerance for overshoot of the process value setpoint temperature, For example, where there is little tolerance for overshoot, the deadband span of the heater may be very large, for instance such that the lower temperature is only slightly less than the desired setpoint temperature of the system. When the system can tolerate a larger degree of overshoot, a narrower deadband may be chosen. According to various aspects of the disclosure, (1) the high limit temperature THL and the dead-band temperature span TDB of the heating element temperature control module 376 and (2) the upper limit temperature TU and the lower limit temperature TL of the system temperature control module 374 can be programmed separately and independently from one another.

Referring to FIG, 5, an exemplary operation 590 of the temperature controller 150 is now described. The exemplary operation 590 begins at step S500 when the temperature controller 150 receives instructions to determine whether the heating element 130 should be activated to heat the vessel 110 and any fluid therein. The operation then proceeds to step S505.

In step S505, the heating element current switching module 376 receives the temperature TH of the heating element 130 from the sensor 142. The operation then continues to step S510.

In step S510, the heating element current switching module 376 determines whether the temperature TH at the surface of the heating element 130 is greater than or equal to a predetermined high limit temperature THL. If the temperature TH at the surface of the heating element is not greater than or equal to the predetermined high limit temperature THL, the operation continues to step S515.

In step S515, the second switch 380 is closed (or if already closed, remains closed) and the operation proceeds to step S520.

In step S520, the system temperature control module 374 receives the temperature TPV of the vessel 110 or the fluid in the vessel 110 from the sensor 140. The operation next proceeds to step S525.

In step S525, the system temperature control module 374 determines whether the temperature TPV is less than a predetermined lower limit temperature TL. If the temperature TPV is less than the lower limit temperature TL, the operation continues to step S530 where the first switch 378 is closed (or if already closed, remains closed) and the heating element 130 is energized (or continues to be energized). The operation then returns to step S505.

In step S525, if the system temperature control module 374 determines that the temperature TPV is not less than the lower limit temperature TL, the operation proceeds to step S535.

In step S535, the system temperature control module 374 determines whether the temperature TPV is greater than a predetermined upper limit temperature TU. If the temperature TPV is not greater than the upper limit temperature TU, the operation continues to step S530.

In step S530, the first switch 378 is closed (or if already closed, remains closed) and the heating element 130 is energized (or continues to be energized). The operation then returns to step S505.

If, however, the system temperature control module 374 determines that the temperature TPV is greater than a predetermined upper limit temperature TU in step S535, the operation proceeds to step S540 where the first switch 378 is opened (or if already opened, remains open) and power to the heating element 130 is interrupted. The operation then goes to step S550.

In step S510, if the heating element current switching module 376 determines that the temperature TH at the surface of the heating element 130 is greater than or equal to the predetermined high limit temperature THL, the operation proceeds to step S545 where the second switch 380 is opened (or if already opened, remains open) and power to the heating element 130 is interrupted. The operation then proceeds to step S550.

In step S550, the heating element current switching module 376 receives the temperature TH at the surface of heating element 130 from the sensor 142. The operation then continues to step S555.

In step S555, the heating element current switching module 376 determines whether the temperature TH of the heating element 130 is less than the predetermined high limit temperature THL minus a predetermined deadband temperature span TDB (THL−TDB). If the temperature TH at the surface of the heating element is less than the predetermined high limit temperature THL minus the predetermined deadband temperature span TDB (THL−TDB), the operation continues to step S515,

In step S515, the second switch 380 is closed (or if already closed, remains closed) and the operation proceeds to step S520.

If, in step S555, the heating element current switching module 376 determines that the temperature TH of the heating element 130 is not less than the predetermined high limit temperature THL minus the predetermined deadband temperature span TDB (THL−TDB), the operation returns to step S550.

The operation 590 continues until the temperature controller 150 is deactivated.

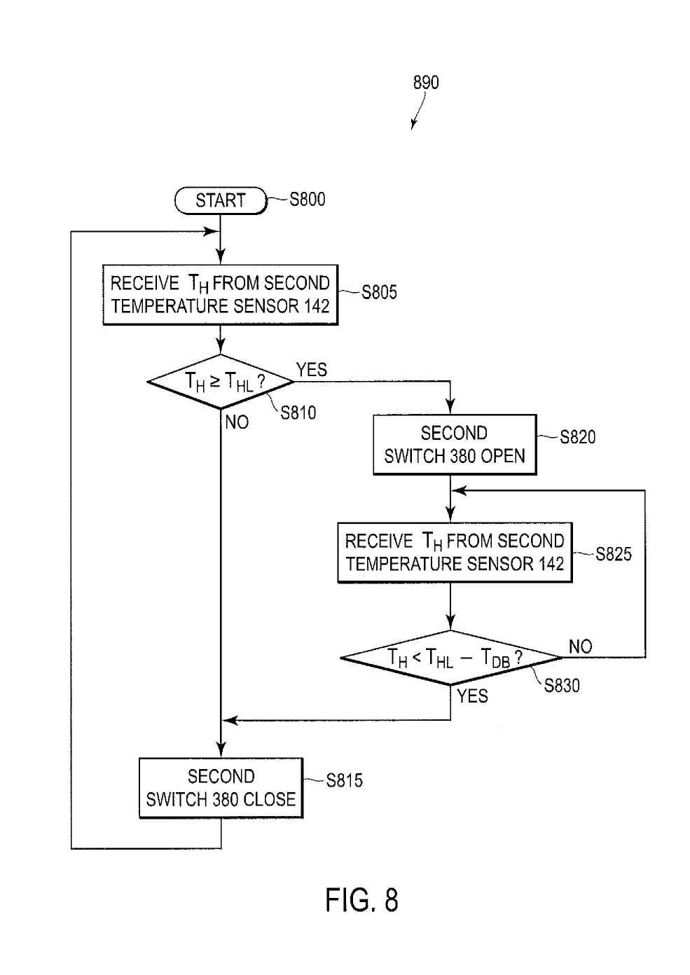

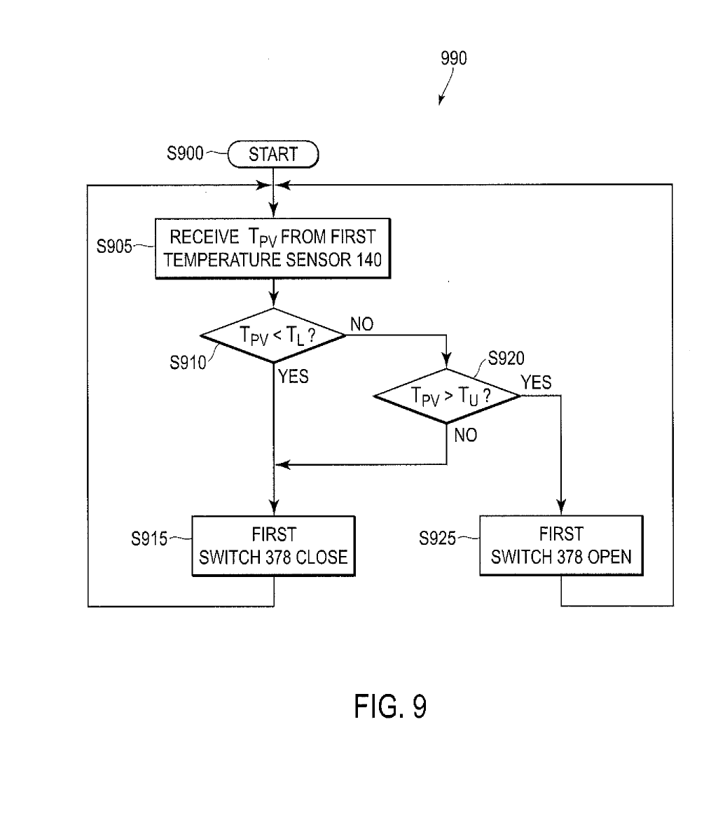

While, in FIG, 5, the operation of the system temperature control module 374 and the heating element current switching module 376 are coordinated in a single operation process, in other embodiments of this invention, the operation of the modules 374, 376 can be independent. For example, the operation of the heating element current switching module 376 can be carried out as illustrated in FIG. 8, and the operation of the system temperature control module 374 can be carried out as illustrated in FIG. 9.

Referring to FIG. 8, an exemplary independent operation 890 of the heating element current switching module 376 is now described. The exemplary operation 890 begins at step S800 when the heating element current switching module 376 receives instructions to determine whether the heating element 130 should be activated to heat the vessel 110 and any fluid therein. The operation then proceeds to step S805.

In step S805, the heating element current switching module 376 receives the temperature TH of the heating element 130 from the sensor 142. The operation then continues to step S810.

In step S810, the heating element current switching module 376 determines whether the temperature TH of the heating element 130 is greater or equal to than a predetermined high limit temperature THL. If the temperature at the surface of the heating element is not greater than or equal to the predetermined high limit temperature THL, the operation continues to step S815.

In step S815, the second switch 380 is closed (or if already closed, remains closed) and the operation returns to step S805,

In step S810, if the heating element current switching module 376 determines that the temperature TH at the surface of the heating element 130 is greater than or equal to the predetermined high limit temperature THL, the operation proceeds to step S820 where the second switch 380 is opened (or if already opened, remains open) and power to the heating element 130 is interrupted. The operation then proceeds to step S825.

In step S825, the heating element current switching module 376 receives the temperature TH of the heating element 130 from the sensor 142. The operation then continues to step S830.

In step S830, the heating element current switching module 376 determines whether the temperature TH of the heating element 130 is less than the predetermined high limit temperature THL minus a predetermined deadband temperature span TDB (THL−TDB). If the temperature at the surface of the heating element TH is less than the predetermined high limit temperature THL minus the predetermined deadband temperature span TDB (THL−TDB), the operation continues to step S815.

In step S815, the second switch 380 is closed (or if already closed, remains closed) and the operation returns to step S805.

If, in step S830, the heating element current switching module 376 determines that the temperature TH of the heating element is not less than the predetermined high limit temperature THL minus the predetermined deadband temperature span TDB (THL−TDB), the operation returns to step S825,

The operation 890 continues until the heating element temperature control module 376 is deactivated.

Referring to FIG. 9, an exemplary independent operation 990 of the system temperature control module 374 is now described. The exemplary operation 990 begins at step S900 when the heating element temperature control module 376 receives instructions to determine whether the heating element 130 should be activated to heat the vessel 110 and any fluid therein. The operation then proceeds to step S905.

In step S905, the system temperature control module 374 receives the temperature TPV of the vessel 110 or the fluid in the vessel 110 from the sensor 140. The operation next proceeds to step S910.

In step S910, the system temperature control module 374 determines whether the temperature TPV is less than a predetermined lower limit temperature TL, If the temperature TPV is less than the lower limit temperature TL, the operation continues to step S915 where the first switch 378 is closed (or if already closed, remains closed) and the heating element 130 is energized (or continues to be energized). The operation then returns to step S905,

In step S910, if the system temperature control module 374 determines that the temperature TPV is not less than the lower limit temperature TL, the operation proceeds to step S920,

In step S920, the system temperature control module 374 determines whether the temperature TPV is greater than a predetermined upper limit temperature TU. If the temperature TPV is not greater than the upper limit temperature TU, the operation continues to step S915.

In step S915, the first switch 378 is closed (or if already closed, remains closed) and the heating element 130 is energized (or continues to be energized). The operation then returns to step S905.

If, in step S920, the system temperature control module 374 determines that the temperature TPV is greater than a predetermined upper limit temperature TU, the operation proceeds to step S925 where the first switch 378 is opened (or if already opened, remains open) and power to the heating element 130 is interrupted. The operation then returns to step S905.

Regardless of the control operation, switches 378, 380 must both be closed for electricity to be delivered to the heating element 130.

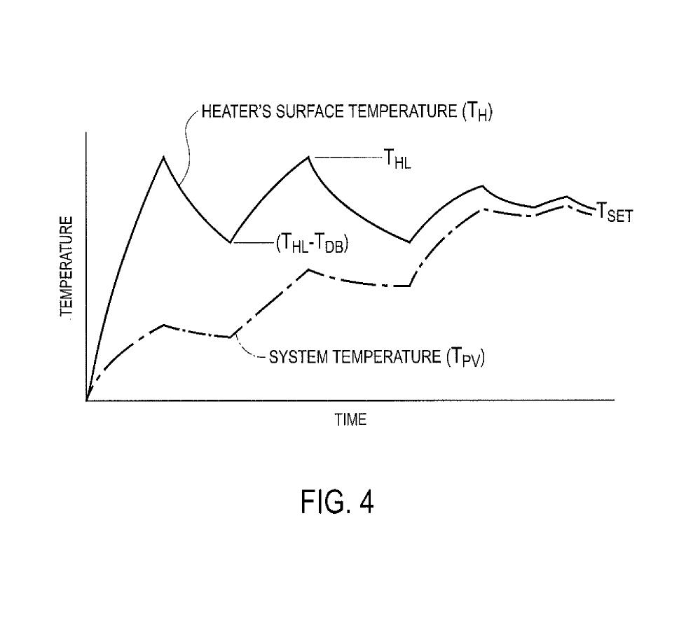

One advantage of the system 100 when operated in accordance with the operation 590 or operations 890, 990 is that the system 100 is quickly and efficiently heated, until the temperature TPV reaches the desired setpoint temperature TSET, in a manner such that the electrical resistance heating element 130 neither overheats nor damages the vessel 110 it is heating, while enabling system functionality over a very wide ambient temperature range, FIG. 4 illustrates the functions, relative to time, of the surface temperature TH of the heating element 130 and the temperature TPV of the system 100 when the system 100 is heated in accordance with operation 590 or operations 890, 990.

As illustrated in FIG. 4, the temperature TPV of the vessel 110 is raised to the desired setpoint temperature TSET by the heating element 130 as follows.

Initially, when the system 100 is activated, the surface temperature TH of the heating element 130 may rapidly reach the high limit temperature THL of the heating element 130. As illustrated in FIG. 4, the temperature TPV rises with the surface temperature TH of the heating element 130, albeit at a lower rate of heat increase.

Once the surface temperature TH reaches the high temperature limit THL, the operation 590 or the operation 890 causes the surface temperature TH to modulate between the high limit temperature THL and THL−TDB until the setpoint temperature TSET is reached.

More specifically, when the surface temperature TH of the heating element 130 reaches the predetermined high limit temperature THL, the heating element current switching module 376 opens the second switch 380 to interrupt power to the heating element 130. Then, as illustrated in FIG. 4, because the heating element 130 is “off,” the surface temperature TH of the heating element 130 drops. When the surface temperature TH is less than temperature TPV, the temperature TPV drops with the surface temperature TH of the heating element 130, albeit at a lower rate.

Once the surface temperature TH drops to a temperature equal to the predetermined high limit temperature THL minus the predetermined deadband temperature span TDB (THL−TDB), the heating element current switching module 376 closes the second switch 380 to energize the heating element 130. Once again, the surface temperature TH of the heating element 130 may rapidly rise until it reaches the high limit temperature THL, while the temperature TPV rises at a lower rate. This operation repeats until the temperature TPV reaches the desired setpoint temperature TSET. Thus, the effective deadband span TDB of the high limit temperature decreases as the system temperature TPV gets closer to the desired setpoint temperature TSET.

In addition and simultaneously, the operation of the system 100 is dependent on the relationship between (1) the temperature TPV and (2) the predetermined upper limit temperature TU and the predetermined lower limit temperature TL. Initially, the switch 378 is in the closed position. When the temperature TPV becomes greater than the predetermined upper limit temperature TU, the switch 378 is moved to the open position. The switch 378 then remains in the open position until the temperature TPV is less than the predetermined lower limit temperature TL, at which time the switch 378 is returned to the closed position.

As a result of the aforementioned system 100 and the operation 590 or the operation 890, damage to the heating element 130 and the vessel 110 can be avoided by preventing the heating element 130 from overheating beyond the high limit temperature THL through control of the second switch 380. In addition, as illustrated in FIG. 4, the system 100 and operations 590, 890 can provide rapid and efficient heating.

As stated above, the vessels that can embody or utilize this invention include fluid containers. FIG. 6 illustrates a fluid container that embodies this invention.

Specifically, and referring to FIG. 6, an exemplary controllable heated vessel system 600 may include a vessel 610, a heating element 630 associated with the vessel 610, a controller 650 configured to control operation of the heating element 630 to maintain a desired temperature of fluid in the vessel 610, and an outer layer 660 covering the controller 650, the heating element 630, and the vessel 610.

In the particular embodiment of FIG. 6, the vessel 610 is a jacket for an oil filter 602. The heating element 630 is a silicone rubber heater. The second temperature sensor 642, for example, a resistance temperature detector, is arranged to detect the temperature at the surface of the heating element 630. The controller 650 is a power board includes the first and second switches 378, 380 that can modulate power to the heating element 630. The controller 650 may also contain the mean system temperature sensor 140. The outer layer 660 can be a molded insulation jacket comprising, for example, a polyamide (nylon) foam.

The function and operation of the vessel system 600 may correspond to that described above in connection with the vessel system 100 and operations 590, 890, 990.

The vessel systems 100, 600 can be utilized in various types of diesel-powered equipment, as well as in non-diesel-powered equipment. For example, the vessel system 100 can be adapted for use with fuel lines or hoses carrying diesel fuel and operated to prevent the diesel fuel from gelling within the lines or hoses. The vessel system 600 can be utilized with fuel injectors and filters, for example, in diesel-powered equipment, and operated to prevent the diesel fuel from gelling within the injector or filter. In some embodiments, the vessel system 600 can be adapted for use with containers containing diesel exhaust fluid and operated to prevent the diesel exhaust fluid from freezing or to thaw diesel exhaust fluid that has frozen. In other embodiments, the vessel systems 100, 600 can be adapted for use with a filter housing and/or drain lines. For example, the vessel systems 100, 600 can be adapted for use with closed crankcase ventilator filter housings and drain lines and operated to prevent freezing of fluid therein.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

The foregoing description of exemplary embodiments provides illustration and description, but is not intended to be exhaustive or to limit the embodiments described herein to the precise form disclosed. Modifications and variations are possible in light of the above teachings or may be acquired from practice of the embodiments.

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above mentioned description is to be considered exemplary, rather than limiting, and the true scope of the invention is that defined in the following claims.

What is claimed is:

1. A heated vessel system, comprising:
a vessel for containing a fluid;
a heating element in contact with the vessel and configured to heat the vessel;
a first temperature sensor configured to sense a temperature of the vessel or the fluid in the vessel;
a second temperature sensor connected to the heating element so as to sense a temperature of the heating element; and
a controller for selectively operating the heating element to control the temperature of the vessel or the fluid in the vessel, the controller being configured to (1) interrupt energizing of the heating element when the temperature of the heating element reaches a selected high limit temperature of the heating element and (2) interrupt energizing of the heating element when the temperature of the vessel or the fluid in the vessel exceeds a selected upper limit temperature.

2. The heated vessel system of claim 1, wherein the controller is configured to interrupt energizing of the heating element by opening a switch disposed between a source of energy and the heating element.

3. The heated vessel system of claim 1, wherein the second temperature sensor is directly connected to the heating element and configured to sense a surface temperature of the heating element.

4. The heated vessel system of claim 1, wherein when the controller interrupts energizing of the heating element because the temperature of the heating element reaches the selected high limit temperature of the heating element, the controller is configured to continue interrupting energizing of the heating element until the temperature of the heating element reaches a selected low temperature of the heating element that is below the selected high limit temperature of the heating element.

5. The heated vessel system of claim 4, wherein the controller is configured to permit energizing of the heating element when the temperature of the heating element reaches the selected low temperature of the heating element.

6. The heated vessel system of claim 1, wherein when the controller interrupts energizing of the heating element because the temperature of the vessel or the fluid in the vessel exceeds the selected upper limit temperature, the controller is configured to continue interrupting energizing of the heating element until the temperature of the vessel or the fluid in the vessel reaches a selected low-limit temperature that is below the selected upper limit temperature.

7. The heated vessel system of claim 6, wherein the controller is configured to permit energizing of the heating element when the temperature of the vessel or the fluid in the vessel reaches the selected low-limit temperature.

8. The heated vessel system of claim 1, wherein the heating element is on the vessel.

9. The heated vessel system of claim 1, wherein the heating element is at least partially embedded in a wall of the vessel.

10. The heated vessel system of claim 1, wherein the vessel is a conduit having a first end and a second end, the heating element is between the first end and the second end of the conduit.

11. A method of controllably operating a heated vessel system having a vessel for containing fluid and a heating element to heat the vessel, the method comprising:
sensing a temperature of the heating element;
sensing a temperature of the vessel or fluid in the vessel; and
selectively operating the heating element to heat the vessel, the step of selectively operating including (1) interrupting energizing of the heating element when the temperature of the heating element reaches a selected high limit temperature of the heating element and (2) interrupting energizing of the heating element when the temperature of the vessel or the fluid in the vessel exceeds a selected upper limit temperature.

12. The method of claim 11, wherein the interrupting energizing of the heating element of the selectively operating step includes opening a switch disposed between a source of energy and the heating element.

13. The method of claim 11, further comprising the step of, when energizing of the heating element is interrupted because the temperature of the heating element reaches the selected high limit temperature of the heating element, continuing interruption of energizing of the heating element until the temperature of the heating element reaches a selected low temperature of the heating element that is below the selected high limit temperature of the heating element.

14. The method of claim 13, further comprising the step of permitting energizing of the heating element when the temperature of the heating element reaches the selected low temperature of the heating element.

15. The method of claim 11, further comprising the step of, when energizing of the heating element is interrupted because the temperature of the vessel or the fluid in the vessel exceeds the selected upper limit temperature, continuing interruption of energizing of the heating element until the temperature of the vessel or the fluid in the vessel reaches a selected low-limit temperature that is below the selected upper limit temperature.

16. The method of claim 15, further comprising the step of permitting energizing of the heating element when the temperature of the vessel or the fluid in the vessel reaches the selected low-limit temperature.

17. A heated vessel system, comprising:
a vessel for containing a fluid;
a heating element in contact with the vessel and configured to heat the vessel;
a first temperature sensor configured to sense a temperature of the vessel or the fluid in the vessel;
a second temperature sensor connected to the heating element so as to sense a temperature of the heating element; and
a controller for selectively operating the heating element to control the temperature of the vessel or the fluid in the vessel, the controller being configured to permit energizing of the heating element when (1) the temperature of the heating element is less than a selected high limit temperature of the heating element and (2) the temperature of the vessel or the fluid in the vessel is less than or equal to a selected upper limit temperature.

18. The heated vessel system of claim 17, wherein the controller is configured to (1) interrupt energizing of the heating element when the temperature of the heating element reaches the selected high limit temperature of the heating element, (2) continue interrupting energizing of the heating element until the surface temperature of the heating element reaches a selected low temperature of the heating element that is below the high limit temperature of the heating element, and (3) permit energizing of the heating element when the surface temperature of the heating element reaches the selected low temperature of the heating element.

19. The heated vessel system of claim 17, wherein the controller is configured to (1) interrupt energizing of the heating element when the temperature of the vessel or the fluid in the vessel exceeds the selected upper limit temperature, (2) continue interrupting energizing of the heating element until the temperature of the vessel or the fluid in the vessel reaches a selected low-limit temperature that is below the selected upper limit temperature, and (3) permit energizing of the heating element when the temperature of the vessel or the fluid in the vessel reaches the selected low-limit temperature.

20. The heated vessel system of claim 17, wherein the second temperature sensor is directly connected to the heating element and configured to sense a surface temperature of the heating element.
